(19) United States
(12) Patent Application Publication
(10) Pub. No.: US 2008/0281579 A1
(43) Pub. Date: Nov. 13, 2008

(54) Method and System for Facilitating The Learning of A Language

(75) Inventors: Shuichiro Tsukiji, Santa Clara, CA (US); Ritsuko Nishide, Santa Clara, CA (US)

Correspondence Address: OSHA LIANG L.L.P., 1221 MCKINNEY STREET, SUITE 2800, HOUSTON, TX, 77010, US

(73) Assignee: Omron Advanced Systems, Inc., Santa clara, CA (US)

(21) Appl. No.: 11/947,471

(22) Filed: Nov. 29, 2007

Related U.S. Application Data
(60) Provisional application No. 60/917,295, filed on May 10, 2007.

(51) Int. Cl. G06F 17/28

(52) U.S. Cl. 704/3

(57) ABSTRACT

A method for facilitating the learning of a language, involves concurrently displaying a video and subtitles corresponding to the video, where the displayed subtitles include selectable sentences, obtaining a selection from a user, including a selected sentence of the selectable sentences, subsequently displaying the selected sentence for selection of a word, obtaining a word selection of the selected sentence from the user, searching for and displaying at least one description including the user selected word.

### BACKGROUND OF INVENTION

People often need to learn one or more new languages or better develop their skills for a language previously learned. Many books and software programs have been created to facilitate the learning of a new language. For example, a simple language learning software application may take input in one language and provide a translation of the input in a different language. In this case, a language learner is required to know which word he wants to translate and enter the word using a keypad. Thereafter, the user must remember the translated word and put the word into context using other words known to the user.

Some language learning software applications present the most common words and/or phrases to a language learner. For example, a software application may present most commonly used words in the new language and in a language known to the user, e.g., a ordinary conversation in a usual environment. Accordingly, the user associates the words in the new language with words in the language known to the user.

Alternatively, some language learning software applications may make the use of still images to help a user learn a new language. For example, a software application may present common words and/or phrases with a corresponding image for the user to associate the word with the image. In this case, the user learns the words one at a time in the order presented by the language learning software.

### SUMMARY OF INVENTION

In general in one aspect, the invention relates to a method for facilitating the learning of a language, comprising: concurrently displaying a video and subtitles corresponding to the video, wherein the displayed subtitles comprise a plurality of selectable sentences; obtaining a selection from a user, comprising a selected sentence of the plurality of selectable sentences; subsequently displaying the selected sentence for selection of a word; obtaining a word selection of the selected sentence from the user; searching for and displaying at least one description comprising the user selected word.

In general in one aspect, the invention relates to a method for facilitating the learning of a language, comprising: concurrently displaying a video and subtitles corresponding to the video, wherein the displayed subtitles comprise a plurality of selectable words; obtaining a selection from a user, comprising a selected word of the plurality of selectable words; searching for and displaying at least one description comprising the user selected word.

In general in one aspect, the invention relates to a system for displaying a form, comprising: a data repository, comprising a video, subtitles corresponding to the video, a description of a word comprised in the subtitles; a user interface, comprising functionality to concurrently display the video and the corresponding subtitles as a plurality of selectable sentences, obtain a selection from a user comprising a sentence selected from the plurality of selectable sentences by a user and a word selected from the selected sentence, display at least one description comprising the user selected word; and a management engine comprising functionality to search for the at least one description comprising the user selected word.

In general in one aspect, the invention relates to a user interface, comprising: a video frame comprising a video; a subtitles frame comprising a plurality of selectable sentences corresponding to the video, and a sentence selector comprising functionality to select a sentence of the plurality of selectable sentences; a word selection frame comprising the selected sentence, and a word selector comprising functionality to select a word of the selected sentence; and a description frame comprising a description associated with the selected word.

In general in one aspect, the invention relates a computer readable medium comprising instructions for facilitating the learning of a language, the instructions comprising functionality for: concurrently displaying a video and subtitles corresponding to the video, wherein the displayed subtitles comprise a plurality of selectable sentences; obtaining a selection from a user, comprising a selected sentence of the plurality of selectable sentences; subsequently displaying the selected sentence for selection of a word; obtaining a word selection of the selected sentence from the user; searching for and displaying at least one description comprising the user selected word.

Other aspects and advantages of the invention will be apparent from the following description and the appended claims.

### BRIEF DESCRIPTION OF DRAWINGS

FIG. 1 shows a system in accordance with one or more embodiments of the invention.

FIGS. 2A and 2B show a user interface in accordance with one or more embodiments of the invention.

FIG. 3 shows a flow chart in accordance with one or more embodiments of the invention.

FIG. 4 shows an example of a user interface in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for facilitating the learning of a language. Specifically, embodiments of the invention allow for a concurrent display of video and corresponding subtitles, obtaining a user selection of at least a portion of the subtitles, and providing descriptions of the user selections.

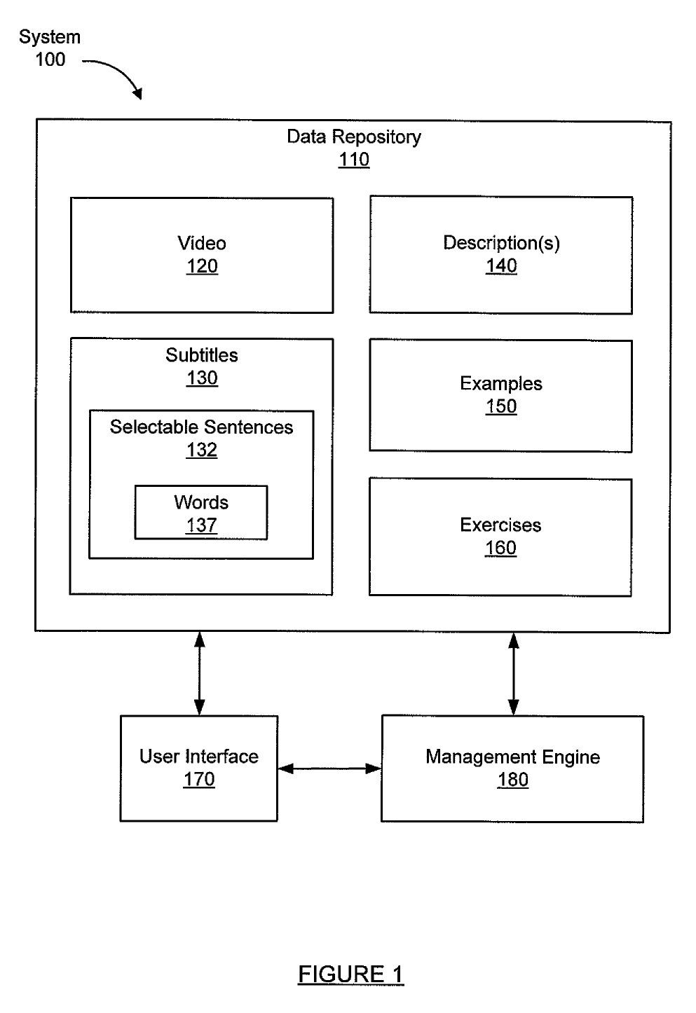

FIG. 1 shows a system (100) in accordance with one or more embodiments of the invention. As shown in FIG. 1, the system (100) includes a data repository (110), a user interface (170), and a management engine (180). Each of these components are described below and may be located on the same device (e.g., a server, mainframe, desktop personal computer (PC), laptop, personal desktop assistant (PDA), television, cable box, satellite box, kiosk, telephone, mobile phone, or other computing devices) or may be located on separate devices coupled by a network (e.g., Internet, Intranet, Extranet, Local Area Network (LAN), Wide Area Network (WAN), or other network communication methods), with wire and/or wireless segments.

In one or more embodiments of the invention, the system (100) is implemented using a client-server topology. The system (100) itself may be an enterprise application running on one or more servers, and in some embodiments could be a peer-to-peer system, or resident upon a single computing system. In addition, the system (100) is accessible from other machines using one or more interfaces (e.g. interface (170), web portals (not shown), or any other tool to access the system). In one or more embodiments of the invention, the system (100) is accessible over a network connection (not shown), such as the Internet, by one or more users. Information and/or services provided by the system (100) may also be stored and accessed over the network connection.

In one or more embodiments of the invention, the data repository (110) includes functionality to store video (120), subtitles (130), descriptions (140), examples (150), and exercises (160). In one or more embodiments of the invention, access to the data repository (110) is restricted and/or secured. As such, access to the data repository (110) may require authentication using passwords, secret questions, personal identification numbers (PINs), biometrics, and/or any other suitable authentication mechanism. Those skilled in the art will appreciate that elements or various portions of data stored in the data repository (110) may be distributed and stored in multiple data repositories. In one or more embodiments of the invention, the data repository (110) is flat, hierarchical, network based, relational, dimensional, object modeled, or structured otherwise. For example, data repository (110) may be maintained as a table of a SQL database. In addition, data in the data repository (110) may be verified against data stored in other repositories.

Continuing with FIG. 1, in one or more embodiments of the invention, the video (120) shown as stored in the data repository (110) corresponds to a video component of a media file (e.g., an mpeg2 file). In one or more embodiments of the invention, the video (120) may be a show, a movie, a short clip, a documentary film, an animation, an educational program, or any other type of video that is associated with a dialogue. The video (120) may be in any format including but not limited to, an audio video interleave format (AVI), a windows media format (MWV), a moving pictures expert group format (MPEG), a moving pictures expert group 2 format (MPEG2), QuickTime format, RealVideo format (RM or RAM), and/or a Flash format (SWF). The video (120) may or may not be associated with corresponding sound, i.e., the video (120) may be silent.

In one or more embodiments of the invention, subtitles (130) shown as stored in the data repository (110) correspond to text associated with the video (120), e.g., closed caption for a movie. The subtitles (130) may correspond to a portion or all of the dialogue in the video (120). The subtitles (130) include sentences (132) that are selectable when displayed on an interface (e.g., user interface (170)).

In one or more embodiments of the invention, each selectable sentence (132) corresponds to text displayed for a predetermined time period associated with the video (120). For example, a selectable sentence may be displayed from time 1:20:54.100 (Hours:Minutes:Seconds) to 1:20:57.867 relative to the start time of the corresponding video. Different selectable sentences (132) may also temporally overlap (i.e., be displayed at the same time) and each sentence (132) may be selected by a user. The selectable sentences (132) correspond to a combination of one or more words (137) that may or may not form a single grammatically complete sentence. A selectable sentence (132) may also correspond to more than one grammatically complete sentence. In one or more embodiments of the invention, each selectable sentence (132), as a whole, may be selected by a user for an immediate use or selected (i.e., marked) for later use. For example, the data repository may include an indicator (not shown) for each selectable sentence, that indicates whether the sentence has been selected by a user. Alternatively, a copy of the selected sentences (not shown) may be stored separately in the data repository.

In one or more embodiments of the invention, the words (137) within a selectable sentence (132) correspond to one or more units of a language that function as principal carriers of meanings. The words (137) within a selectable sentence (132) may themselves be individually selectable when displayed. In one or more embodiments of the invention, a single word (137) or a group of words (137) (e.g., a phrase) may be defined, and/or explained through descriptions (140), examples (160), and exercises (170).

The descriptions (140) correspond to text associated with the word (137) that facilitates the understanding of the word (137), in accordance with one or more embodiments of the invention. For example, the description associated with a word may be a definition of a word, a use of a word, a history of a word, a synonym, a conjugation, a translation of a word or any other suitable text for facilitating the understanding of the word. In one or more embodiments of the invention, the description (140) may be part of a database available on a network (e.g., an online dictionary).

The examples (150) correspond to different occurrences of the word (137) within the subtitles (130), in accordance with one or more embodiments of the invention. For instance, the examples (150) may correspond to one or more selectable sentences (132) in the subtitles (130) that include different occurrences of a selected word. The examples (150) may also include a portion of the video (120) corresponding to one or more sentences (132) in the subtitles (130) that include different occurrences of the selected word. For instance, if the selected word is “confiscate,” an example may include another occurrence of the word “confiscate” not selected by the user and may further include the portion of the video corresponding to the other occurrence of the word “confiscate.”

In one or more embodiments of the invention, the exercise(s)(160) corresponds to an interactive lesson that facilitates the understanding of a word (137). The exercise(s) (160) may include a virtual instructor and/or a virtual co-learner for interaction with the user. In one or more embodiments of the invention, the exercises (160) are pre-generated for a group of words (137) and activated upon request by a user. In another embodiment of the invention, the exercise (160) may be dynamically generated based on a user selected word (137). For example, when a user selects a word, an exemplary use of the word may be searched and found and thereafter converted into a question format to be presented by the virtual instructor. Accordingly, in one or more embodiments of the invention, the selection of a single word (137) may result in different exercises (160) being generated based on the use of the word that is found at the time of the selection. In one or more embodiments of the invention, different exercises (160) may correspond to different difficulty levels, where a user may be able to select a difficulty level and complete a suitable exercise that is selected based on the difficult level.

In one or more embodiments of the invention, the management engine (180) corresponds to a process, program, and/or application that interacts with the data repository (110) and the user interface (170) to facilitate the learning of a language. In one or more embodiments of the invention, the management engine (180) may include functionality to extract text from a media file to generate the subtitles (130). The management engine (180) may further include functionality to search for descriptions (140) matching the selected words (137), generate or select exercises (160) for the selected words (137), and find examples (150) of the selected words (137) within the subtitles (130). The management engine (180) may also include functionality to rank a video (120) and the corresponding subtitles (130) according to a difficulty index based on the difficulty level of the words (137) within the subtitles (130). Furthermore, the management engine (180) may include functionality to select different hints for a user, depending on the difficulty level of the words or the difficulty index of the video (120), during an exercise (160).

Continuing with FIG. 1, the interface (170) corresponds to one or more interfaces adapted for use to access the system (100) and any services provided by the system (100). In one or more embodiments of the invention, the interface (170) includes functionality to present video (120), subtitles (130), descriptions (140), examples (150), and exercises (160) and obtain user selections from the selectable sentences (132) and/or user selections of one or more words (137).

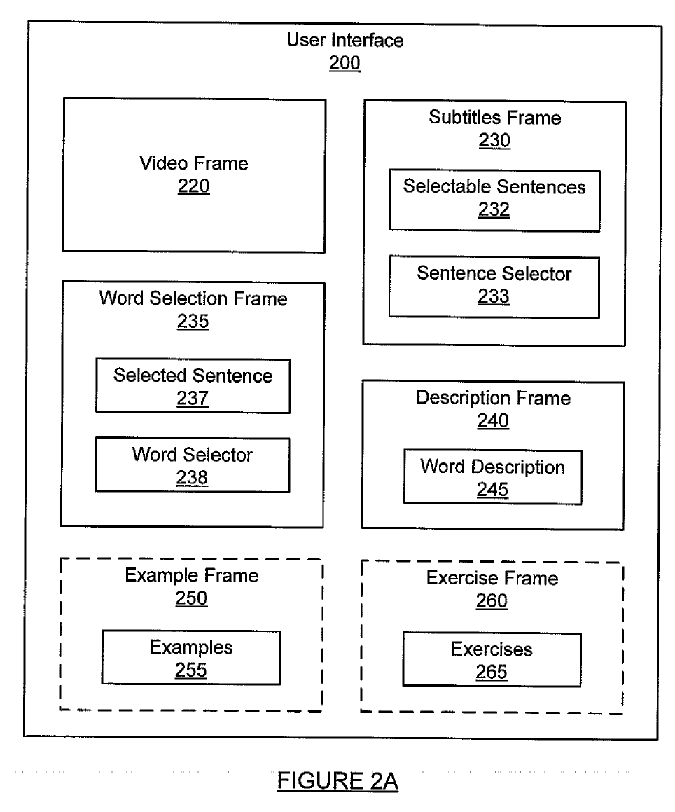

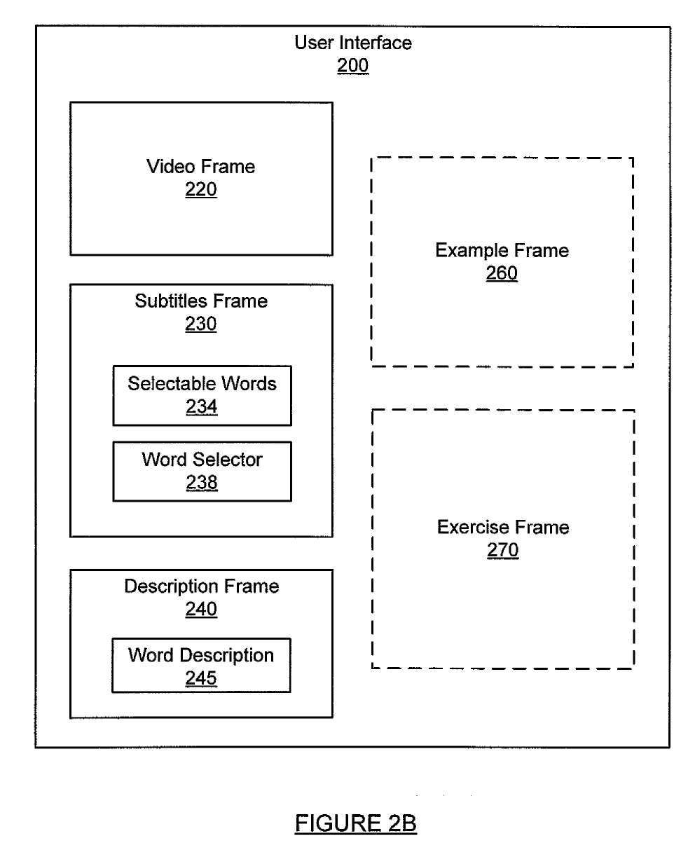

The user interface (170) may be a web interface, a graphical user interface (GUI), a command line interface, an application interface or any other suitable interface. The user interface (170) may include one or more web pages that can be accessed from a computer with a web browser and/or internet connection. Alternatively, the user interface (170) may be an application that resides on a computing system, such as a PC, mobile devices (e.g., cell phones, pagers, digital music players, mobile media centers), a PDA, and/or other computing devices of the users, and that communicate with the system (100) via one or more network connections and protocols. Regardless of the architecture of the system (100), communications between the system (100) and the user interface (170) may be secure, as described above. Individual components and functionalities of user interface (170) are shown in FIGS. 2A and 2B, and discussed below.

The user interface (200) is essentially the same as user interface (170). As shown in FIG. 2A, user interface (200) includes a video frame (220), a subtitles frame (230), a word selection frame (235), and a description frame (240). The user interface (200) may also include an example frame (250), and/or an exercise frame (260). Each of the above frames may be displayed concurrently or may be selectively displayed depending on the operation mode of the user interface (200).

In one or more embodiments of the invention, the video frame (220) corresponds to a portion of the user interface (200) used to display video. The video frame (220) may include functionality to pause, stop, play, rewind and fast forward the video; and adjust volume, and display size. In one or more embodiments of the invention, the above controls may be triggered based on user input to any of the other frames. For example, a selection in the subtitles frame (230) may trigger a pause in the video frame (220).

In one or more embodiments of the invention, the subtitles frame (230) corresponds to a portion of the user interface (200) that includes functionality to display subtitles as selectable sentences (232) concurrently with the corresponding video in the video frame (220). The subtitles frame (230) further includes a sentence selector (233) which may be used to select a displayed selectable sentence (232). Specifically, the sentence selector (233) corresponds to any visual or non-visual tool that may be used to select a displayed selectable sentence (232). For example, the sentence selector may be a mouse pointer which can be used to select a displayed selectable sentence by clicking. Another example may involve numbered selectable sentences, each of which may be selected using a keyboard.

Continuing with FIG. 2A, in one or more embodiments of the invention, the word selection frame (235) corresponds to a portion of the user interface (200) that includes functionality to display a selected sentence (237) (i.e., a selectable sentence (232) that has been selected). The word selection frame (235) may display the entire selected sentence (237) as previously displayed in the subtitles frame (230), or may display particular words in the selected sentence (237). For example, the word selection frame may include functionality to filter out prepositions, and/or words below a particular difficulty level. The word selector (238) corresponds to a tool for selecting a word from the portion of the selected sentence (237) displayed in the word selection frame (235). The word selector (238), similar to the sentence selector (233), may include visual and non-visual tools to make a selection.

As shown in FIG. 2B, in one or more embodiments of the invention, the subtitles frame (230) may include selectable words (234) and the word selector (238) instead of selectable sentences and a sentence selector, i.e., the words may directly be selected from the subtitles frame (230) without the use of the word selection frame (235) shown in FIG. 2A.

Continuing with FIG. 2A, the description frame (240), example frame (250), and exercise frame (260) correspond to different portions of the interface (200) and may each be present at all times or alternatively, may be activated upon user input, e.g., selection of a word by a user. The description frame (240) corresponds to a portion of the interface (200) that includes functionality to display a word description (245) of a selected word, in accordance with one or more embodiments of the invention. In one or more embodiments of the invention, the description frame (240) may include multiple word descriptions (245) for a selected word. The description frame (240) may update the word description (245) after every selection of a word by a user. In one or more embodiments of the invention, the description frame (240) may also be implemented as continuous text, where each word description (245) is dynamically added to the continuous text. All word descriptions (245) in the description frame (240) may accordingly, be navigated (e.g., scrolled) through.

The example frame (250) corresponds to a portion of the user interface (200) that includes functionality to show examples (255), in accordance with one or more embodiments of the invention. As described previously, examples (255) may include video and/or subtitles for alternate occurrences of a selected word. Accordingly, the example frame (250) may include functionality to display subtitles and/or the video of alternate occurrences of a selected word. In one or more embodiments of the invention, the example frame (250) may also include functionality to display videos available on a network (e.g., LAN, internet) that include the selected word.

The exercise frame (260) corresponds to a portion of the user interface (200) that includes functionality to display interactive exercises (265) and obtain input for the exercises (265) from the user. The exercise frame (260) may include multiple sub-frames, e.g., corresponding to the user, an instructor, and/or a co-learner. The instructor and/or the co-learner may be part of a computer generated program to help facilitate learning or may correspond to different users of the system. For example, the co-learner frame may correspond to input from a second user located at the same physical location as a first user, or connected to the user interface via a network (e.g., the internet). Similarly, the instructor frame may also correspond another user or a computer generated animation that receives the user selected words and executes exercises based on the user selected word to facilitate learning. Accordingly, in one or more embodiments of the invention, the exercise frame (260) may be displayed on multiple user interfaces (e.g., user interface (200)) corresponding to a multiple users and used concurrently by the multiple users to facilitate learning of a word selected by at least one connected user.

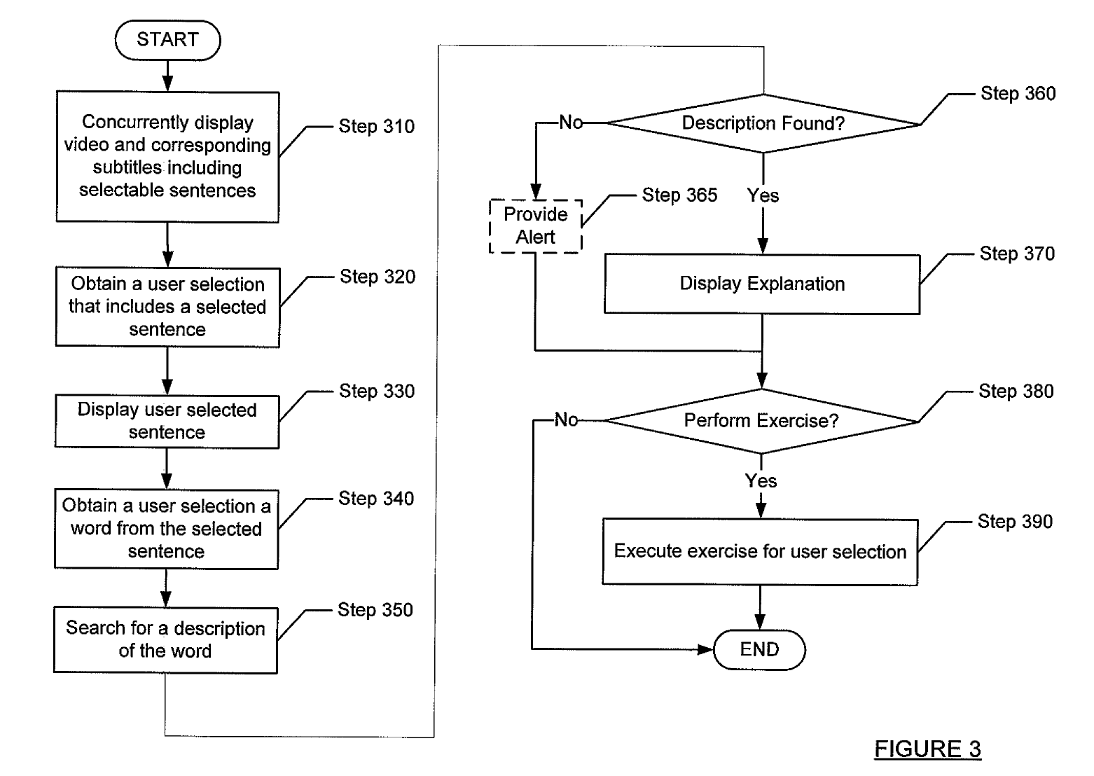

FIG. 3 shows a flow chart for facilitating the learning of a language in accordance with one or more embodiments of the invention. In one or more embodiments of the invention, one or more of the steps described below may be omitted, repeated, and/or performed in a different order. Accordingly, the specific arrangement of steps shown in FIG. 3 should not be construed as limiting the scope of the invention.

Initially, a video and corresponding subtitles made up of selectable sentences are concurrently displayed, in accordance with one or more embodiments of the invention (Step 310). The subtitles may be displayed as layered on top of a portion of the video or in a separate non-overlapping space. Next, a selection of a selectable sentence is obtained from a user (Step 320). Depending on a mode of operation, the selection may result in an immediate display of the user selected sentence (Step 330), or the selected sentence may be marked for a future display of the user selected sentence (Step 330). The future display of the user selected sentence may require further user input. For example, a user may navigate through all selected sentences at any point (e.g., after a section of the video, or completion of the video), and provide user input to display a previously selected sentence. In one or more embodiments of the invention, the display of the user selected sentence may be filtered to include words of a minimum and/or maximum difficulty level. In one or more embodiments of the invention, the display of the user selected sentence may result in pausing the video or alternatively, may be displayed while the video continues in play mode.

Continuing with FIG. 3, a selection of a word, of the selected sentence, is obtained next from a user (Step 340). The selected word may be obtained by the user clicking on a word, entering keyboard input, or providing the selection by any other suitable method. In one or more embodiments of the invention, the selection of the word may be obtained directly after Step 310 discussed above, i.e., Steps 320 and 330 may be skipped. For example, similar to a selectable sentence, a user may directly select a word from the subtitles for immediate use or select a word for future use.

Once the word has been selected, a search for a description of the word is made (Step 350). The description may be searched for in a pre-generated search database corresponding to the subtitles or may be searched for dynamically in a data repository (e.g., over a network). In one or more embodiments of the invention, a search engine on the internet (or any other network), may be used to search for a description of the selected word. Searching for the description may include searching for definitions, synonyms, examples, alternate uses of the selected word in the subtitles, a video corresponding to use of the selected word and/or any other suitable criteria which would facilitate the understanding of the selected word.

If a description is found (Step 360), the description is displayed (Step 370). The description may be displayed concurrently with the video, or alternatively, the description may be displayed after pausing or stopping the video. If the description is not found, an alert may be provided (Step 365). For example, an alert may be provided to a user, to a system administrator, to a programmer, or to any other suitable entity. In one or more embodiments of the invention, the alert may be an instruction to obtain the description at a future time (e.g., when a connection to the internet is available again), or may be an error notification.

Next, after providing the description, a decision is made whether to perform an exercise to better understand the selected word (Step 380). The decision may be based on the difficulty level of the selected word. For example, all words at a predetermined difficulty level are automatically designated for exercises. Alternatively, the decision to perform an exercise may be provided by a user.

Continuing with FIG. 3, in one or more embodiments of the invention, the exercises are executed in an interactive manner with the user (Step 390). The exercises may be performed immediately following a display of a word description or may be performed in groups (e.g., at the end of a section or at the end of the video). In one or more embodiments, of the invention, particular exercises may be skipped by a user. In addition, the exercises may involve multiple users. For example, all user selected words from multiple users may be collected and thereafter all users may participate individually or together in performing exercises for words selected by at least one user.

In one or more embodiments of the invention, words and/or sentences selected by the user may be used to generate a personalized database (not shown). Specifically, the words selected by the user may be stored along with a corresponding description to generate a customized dictionary for the user. Furthermore, the personalized database may include a collection of customized exercises and/or customized examples.

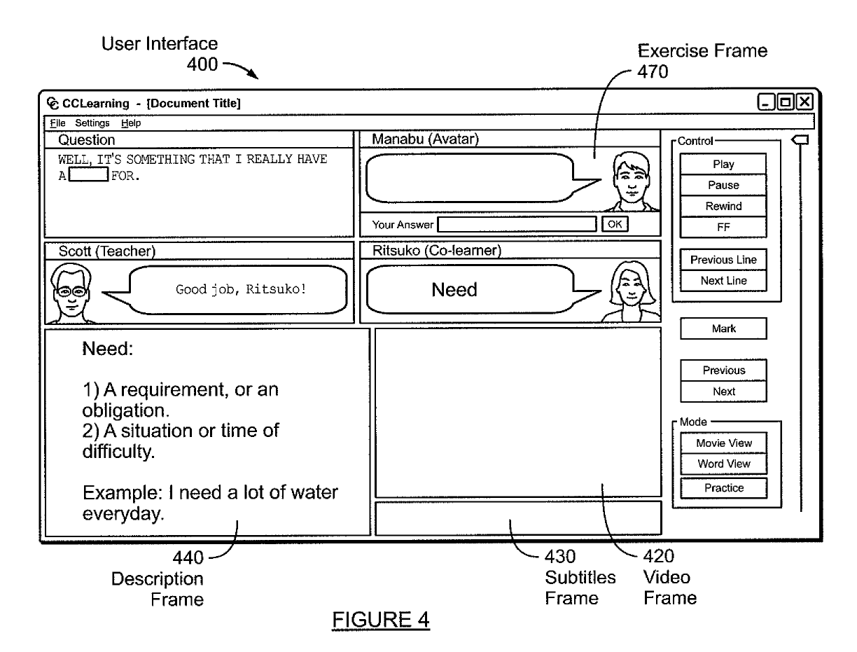

FIG. 4 shows an example of a user interface (400) in accordance with one or more embodiments of the invention. As shown in FIG. 4, the user interface (400) includes a video frame (420), a subtitles frame (430), a description frame (440) and an exercise frame (470). In this example, the word “need” was previously selected from a subtitles frame (430). Accordingly, an exercise for the word “need” is executed by a virtual instructor “Scott” that is part of a computer generated program. The question is presented with a blank for a first user “Manabu (Avatar)” and a second user “Ritsuko (Co-learner)” to answer. In this case the second user answers the question correctly. Thereafter two descriptions of the word “need” are displayed in the description frame (440). As discussed above, one or more of the steps described may be omitted, repeated, and/or performed in a different order.

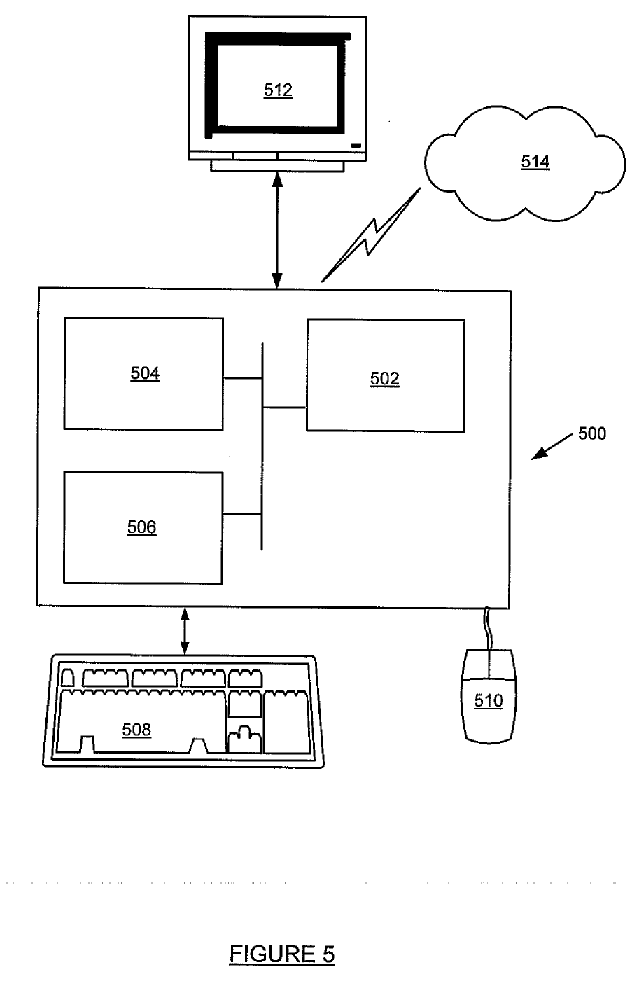

The invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a LAN or a WAN (e.g., the Internet) (514) via a network interface connection. Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., object store layer, communication layer, simulation logic layer, etc.) may be located on a different node within the distributed system.

In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for facilitating the learning of a language, comprising:
concurrently displaying a video and subtitles corresponding to the video, wherein the displayed subtitles comprise a plurality of selectable sentences;
obtaining a selection from a user, comprising a selected sentence of the plurality of selectable sentences;
subsequently displaying the selected sentence for selection of a word;
obtaining a word selection of the selected sentence from the user;
searching for and displaying at least one description comprising the user selected word.

2. The method of claim 1, further comprising:
extracting the subtitles corresponding to the video from a media file;

3. The method of claim 1, wherein the selected sentence is immediately displayed for word selection subsequent to the user selecting the sentence.

4. The method of claim 1, further comprising:
marking the selected sentence; and
obtaining a further user request prior to displaying the selected sentence for selection of the word.

5. The method of claim 1, further comprising:
searching for a description associated with each word comprised in the subtitles and generating a description database associated with the video based on the search.

6. The method of claim 1, further comprising:
identifying a difficulty ranking for each of a plurality of words comprised in the subtitles; and
determining a difficulty index for the video based on the difficulty rank associated with each of the plurality of words;

7. The method of claim 1, further comprising:
executing a language learning exercise selected based on the user selected word.

8. The method of claim 1, further comprising:
identifying a different occurrence of the user selected word in the subtitles and displaying the sentence from the subtitles comprising the different occurrence of the user selected word.

9. A method for facilitating the learning of a language, comprising:
concurrently displaying a video and subtitles corresponding to the video, wherein the displayed subtitles comprise a plurality of selectable words;
obtaining a selection from a user, comprising a selected word of the plurality of selectable words;
searching for and displaying at least one description comprising the user selected word.

10. A system for displaying a form, comprising:
a data repository, comprising:
a video;
subtitles corresponding to the video;
a description of a word comprised in the subtitles;
a user interface, comprising functionality to:
concurrently display the video and the corresponding subtitles as a plurality of selectable sentences;
obtain a selection from a user comprising a sentence selected from the plurality of selectable sentences by a user and a word selected from the selected sentence;
display at least one description comprising the user selected word; and
a management engine comprising functionality to:
search for the at least one description comprising the user selected word.

11. The system of claim 10, wherein the management engine further comprises functionality to:
extract the subtitles corresponding to the video from a media file.

12. The system of claim 10, wherein the data repository further comprises:
a marked sentence, wherein the marked sentence is a sentence selected by a user for future review.

13. The system of claim 10, wherein the management engine further comprises functionality to:
search for a description associated with each word comprised in the subtitles; and
generate a description database associated with the video based on the search.

14. The system of claim 10, wherein the management engine further comprises functionality to:
identify a difficulty ranking for each of a plurality of words comprised in the subtitles; and
determine a difficulty index for the video based on the difficulty rank associated with each of the plurality of words.

15. The system of claim 10, wherein the management engine further comprises functionality to select and execute an exercise based on the selected word.

16. The system of claim 10, wherein the management engine further comprises functionality to identify a different occurrence of the user selected word in the subtitles, and wherein the user interface further comprises functionality to display the different occurrence of the user selected word in context of the subtitles.

17. A user interface, comprising:
a video frame comprising a video;
a subtitles frame comprising:
a plurality of selectable sentences corresponding to the video; and
a sentence selector comprising functionality to select a sentence of the plurality of selectable sentences;
a word selection frame comprising:
the selected sentence; and
a word selector comprising functionality to select a word of the selected sentence; and
a description frame comprising:
a description associated with the selected word.

18. The user interface of claim 15, further comprising:
an example frame comprising a different occurrence of the selected word in context of the plurality of selectable sentences.

19. The user interface of claim 16, further comprising:
an exercise frame comprising an exercise selected based on the selected word.

20. The user interface of claim 19, wherein the exercise frame comprises:
an instructor frame,
a user frame; and
a peer learner frame.

21. A computer readable medium comprising instructions for facilitating the learning of a language, the instructions comprising functionality for:
concurrently displaying a video and subtitles corresponding to the video, wherein the displayed subtitles comprise a plurality of selectable sentences;
obtaining a selection from a user, comprising a selected sentence of the plurality of selectable sentences;
subsequently displaying the selected sentence for selection of a word,
obtaining a word selection of the selected sentence from the user;
searching for and displaying at least one description comprising the user selected word.

22. The computer readable medium of claim 21, wherein the instructions further comprising functionality for:
extracting the subtitles corresponding to the video from a media file;

23. The computer readable medium of claim 21, wherein the instructions further comprising functionality for:
marking the selected sentence; and
obtaining a further user request prior to displaying the selected sentence for selection of the word.

24. The computer readable medium of claim 21, wherein the instructions further comprising functionality for:
searching for a description associated with each word comprised in the subtitles and generating a description database associated with the video based on the search.

25. The computer readable medium of claim 21, wherein the instructions further comprising functionality for:
executing a language learning exercise selected based on the user selected word.
